(19) United States
(12) Patent Application Publication
(10) Pub. No.: US 2021/0209144 A1
(43) Pub. Date: Jul. 8, 2021

(54) INTERNET OF THINGS SENSOR EQUIVALENCE ONTOLOGY

(71) Applicant: International Business Machines Corporation, Armonk, NY (US)

(72) Inventors: Craig M. Trim, Ventura, CA (US); Martin G. Keen, Cary, NC (US); Michael Bender, Rye Brook, NY (US); Victor Povar, Vancouver (CA)

(73) Assignee: International Business Machines Corporation, Armonk, NY (US)

(21) Appl. No.: 16/734,041

(22) Filed: Jan. 3, 2020

(51) Int. Cl. G06F 16/36; G06F 16/35; H04L 29/08

(52) U.S. Cl. CPC G06F 16/367; G16Y 20/10; H04L 67/12; G06F 16/35

(57) ABSTRACT

First and second sets of sensor data from first and second IoT device sensors are collected. A first set of significant sensor data representing a first event is extracted from the first set of sensor data. A set of terms comprising portions of the first set of significant sensor data is weighted. By analyzing the weighted set of terms, a first set of critical variables describing the first event is identified and added to an ontology. Similarly, a second set of significant sensor data is extracted and a second set of critical variables describing the second event is identified and added to the ontology. Using the ontology, it is determined that the first event is of an event type of the second event. The first sensor and the second sensor are classified to be different variants of a class of sensors that is configurable to sense the event type.

### TECHNICAL FIELD

The present invention relates generally to a method, system, and computer program product for sensor equivalence determination. More particularly, the present invention relates to a method, system, and computer program product for an Internet of Things sensor equivalence ontology.

### BACKGROUND

The Internet of Things (IoT) is a system of interrelated computing devices that have unique identifiers and the ability to transfer data over a network such as the Internet. Each IoT device typically includes one or more sensors, for example a camera, microphone, temperature sensor, moisture sensor, wind speed sensor, cloud height sensor, Global Positioning System (GPS) receiver for geolocation capability, accelerometer, object distance determination capability (for example, using sonar, radar, or lidar), another sensor, or a combination of sensors. Each IoT device is also capable of transferring sensor data over a network to another computing system. Some IoT devices report raw sensor data, either continuously or at a particular time interval. Other IoT devices analyze sensor data and report the data only when the analysis indicates that a particular event has occurred, for example when a camera detects an object or person within a particular range of the camera and reports the motion detection.

An ontology is a set of concepts and categories in a subject area that shows properties of the concepts and categories and the relations between them.

### SUMMARY

The illustrative embodiments provide a method, system, and computer program product. An embodiment includes a method that collects, at a server system managing a set of IoT devices, a first set of sensor data from a first sensor in a first IoT device and a second set of sensor data from a second sensor in a second IoT device. An embodiment extracts, using a statistical model, a first set of significant sensor data from the first set of sensor data, the first set of sensor data including data of a first event, the first set of significant sensor data representing the first event. An embodiment weights, according to a set of factors, each term in a first set of terms, a term in the first set of terms comprising a portion of the first set of significant sensor data. An embodiment identifies, by analyzing the weighted first set of terms, a first set of critical variables describing the first event. An embodiment adds, to an ontology, the first set of critical variables. An embodiment extracts, using the statistical model, a second set of significant sensor data from the second set of sensor data, the second set of sensor data including data of a second event, the second set of significant sensor data representing the second event. An embodiment weights, according to the set of factors, each term in a second set of terms, a term in the second set of terms comprising a portion of the second set of significant sensor data. An embodiment identifies, by analyzing the weighted second set of terms, a second set of critical variables describing the first event. An embodiment adds, to the ontology, the second set of critical variables. An embodiment determines, using the ontology, that the first event is of an event type of the second event. An embodiment classifies the first sensor in the first IoT device and the second sensor in the second IoT device to be different variants of a class of sensors that is configurable to sense the event type.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for an Internet of Things sensor equivalence ontology in accordance with an illustrative embodiment;

FIG. 4 depicts an example of analyzing data for an Internet of Things sensor equivalence ontology in accordance with an illustrative embodiment;

FIG. 5 depicts an example of using an Internet of Things sensor equivalence ontology to analyze data in accordance with an illustrative embodiment;

FIG. 6 depicts a flowchart of an example process for an Internet of Things sensor equivalence ontology in accordance with an illustrative embodiment; and

FIG. 7 depicts a flowchart of an example process for an Internet of Things sensor equivalence ontology in accordance with an illustrative embodiment.

### DETAILED DESCRIPTION

The illustrative embodiments recognize that IoT sensor data of an event includes both data that is relevant to the event and data that is not relevant to the event. For example, if an IoT device includes a video camera and an event is an approaching person, some video segments might include motion of the approaching person as well as motion of tree branches blowing in the wind, although only the approaching person is relevant.

The illustrative embodiments also recognize that different sets of IoT sensors often include different combinations of sensors, even when they are used to detect the same or similar events. For example, one model of autonomous vehicle, including a set of IoT sensors, might use a camera and image processing software to recognize a stop sign the vehicle is approaching, while another model of autonomous vehicle might use GPS capability to correlate the vehicle's location with known locations of stop signs.

The illustrative embodiments also recognize that, even when different sets of IoT sensors include the same combination of sensors, the sensors often report event data differently from each other. For example, cameras with different lenses can produce different-looking images of the same scene, due to the lens differences. If one set of IoT sensors includes a camera with a wide-angle lens, and another set of IoT sensors includes a camera with a non-wide-angle lens, the image data generated by the two sets of sensors for the same event—for example, an approaching person—is likely to be correspondingly different. In addition, not every sensor of the same type reports data in the same format or with the same frequency.

The illustrative embodiments also recognize that, because different sets of IoT sensors are not configured identically to each other, it is difficult to directly compare event data produced by different sensor sets. However, requiring that all event data be generated by identically configured sets of sensors is unrealistic and wastes potentially useful data. In addition, generating sets of data conversion algorithms, one for data from each possible sensor set configuration, is time-consuming and often includes data that is not relevant to an event of interest. Thus, the illustrative embodiments recognize that there is an unmet need in the art for an ontology to cross-reference event data, by the type of event, among sensor data from differently-configured sets of sensors.

The illustrative embodiments recognize that the presently available tools or solutions do not address these needs or provide adequate solutions for these needs. The illustrative embodiments used to describe the invention generally address and solve the above-described problems and other problems related to an Internet of Things sensor equivalence ontology

An embodiment can be implemented as a software application. The application implementing an embodiment can be configured as a modification of an existing sensor data analysis system, as a separate application that operates in conjunction with an existing sensor data analysis system, a standalone application, or some combination thereof.

Particularly, some illustrative embodiments provide a method of constructing event type data for an Internet of Things sensor equivalence ontology, and using the resulting ontology to classify sensor data into an event type.

An embodiment collects sets of sensor data. Each set of sensor data includes data collected during a period of time, as well as optional data regarding an event detected within the set of sensor data. As used herein, each set of sensor data is considered to include data of an event, whether or not event detection data is included. Each set of sensor data includes sensor data from a sensor in an IoT device. An IoT device is configurable to include one or more sensors, for example a camera, microphone, temperature sensor, moisture sensor, wind speed sensor, cloud height sensor, Global Positioning System (GPS) receiver for geolocation capability, accelerometer, object distance determination capability (for example, using sonar, radar, or lidar), another sensor, or a combination of sensors. An embodiment is configurable to collect sensor data, or to receive reported sensor data, continuously, at a particular time interval, or when an IoT device-based analysis indicates that a particular event has occurred. For example, an autonomous delivery vehicle, including multiple IoT sensors, might report its GPS location to a dispatch center once per minute. As another example, a home security system including a video camera might report a segment of video data when a camera detects an object or person within a particular range of the camera and classifies the event as an unknown person approaching the home.

An embodiment is also configurable to collect sensor data from a sensor that did not generate the original event data. For example, if the person-detecting home security system also includes a microphone, the system might report sound data for a time period including the person's approach.

An embodiment is also configurable to collect data from a data source other than a sensor, such as a database or data available on a network such as the Internet. For example, wind speed can be useful when analyzing object motion detection events, but an anemometer may be too large to install at a location where motion detection is required. Instead, an embodiment can collect current wind speed data for a nearby location via the Internet.

An embodiment is configurable to obtain informed consent, via an opt-in or opt-out feature, from a user to collect information about the user or monitor a user's location or environment. An embodiment is also configurable to transmit a notification to a user each time the embodiment collects or uses collected information.

An embodiment extracts a set of significant sensor data from a collected set of sensor data, by removing nonessential data from the collected set of sensor data. By removing nonessential data, an embodiment separates an event of interest from background data. To extract significant sensor data, an embodiment uses a statistical model appropriate to the particular sensor or type of sensor that generated the data.

Some types of sensor data are separable, using any suitable technique, into signal and noise components. For example, sound data generated by a microphone is separable into a signal component and a noise component. Thus, an embodiment configured to process sound data uses a statistical model, specific to sound data or to the particular microphone that collected the data, to remove noise from the sound data, leaving only a set of significant sound data.

For some types of sensor data, data that is not significant is data that occurs with more than a threshold frequency, or data detected at more than a threshold number of sensors within a predetermined time range. Thus, an embodiment configured to process some types of sensor data uses a statistical model, specific to the type of data or to the particular sensor that collected the data, to remove data that occurs with more than a threshold frequency, or data detected at more than a threshold number of sensors within a predetermined time range, leaving only a set of significant sensor data. For example, consider video data of an outdoor scene on a windy day. As a result, video data corresponding to tree branches swaying in the wind occurs with more than a threshold frequency. However, because such data occurs so often, it can be considered as background, while a more interesting event—e.g., an approaching person—is occurring in the foreground. Hence, video data corresponding to tree branches swaying in the wind is not significant and can be removed. An embodiment is also configurable to use another presently-available technique to extract significant data.

An embodiment divides the set of significant sensor data into a set of terms, i.e. subsets of the significant sensor data. The number of terms and the manner in which significant sensor data is divided into terms depends on the type of sensor data and the granularity required to analyze a particular type of sensor data. In one non-limiting example, when analyzing audio data, one term might be data for a portion of an audio frequency spectrum over a period of time. In another non-limiting example, when analyzing video data, one term might be a data for a subset of an image over a period of time. For example, if an image is divided into a 3×3 grid, one term might be data of one grid square within all the images collected in one second.

An embodiment weights each term according to a set of factors. An embodiment can be configured to use weights for each factor that are determined by human experts, either individually or according to a policy. Weights can also be determined using a machine learning process, in which a model learns, using any presently-available technique, weight values that are most effective in processing particular types of sensor data or data output by a particular sensor or a sensor with a particular set of characteristics. An embodiment can also be configured to use weights determined by a combination of factors. One factor is a sensor data frequency factor, i.e. the number of times a particular portion of sensor data appears within the set of significant sensor data.

Another factor is a collection frequency factor, i.e. the number of sensors that produced the same sensor data, sets of sensor data matching each other within a predetermined tolerance, or classified the same event within the sensor data. For example, there may be a set of cameras set up in an area. If only one or two of cameras detect a motion at approximately the same time, and the remaining cameras in the set do not detect the motion, data of that motion is likely to be data of an interesting event that should be highly weighted. However, if all the cameras detect a motion at approximately the same time, data of that motion is unlikely to be data of an interesting event, and that should not be highly weighted.

Another factor is a data length normalization factor, to normalize differences between how much data a particular sensor collects for a particular event. For example, different cameras may capture different amounts of data corresponding to a single image. Normalizing differences between sets of sensor data ensures that size differences between sets of sensor data corresponding to an event do not affect later analysis of data of the event.

An embodiment uses the weighted set of terms to build a vector space representation of the set of terms, and analyzes the weighted set of terms to identify a set of critical variables describing the event. Within the set of sensor data, one sensor may have classified an event—for example, motion detection or voice detection. Variables represent data of other sensors that captured data around the time of the event—in other words, context of the event. For example, along with the motion or voice detection, an infrared sensor might have collected data of an object radiating heat consistent with human body temperature, or a GPS might have collected location data for the camera or microphone. Critical variables are variables that are important in further classifying an event. For example, to determine whether an approaching object is a person rather than an inanimate object, the GPS location of the camera detecting the approaching object might not be important, but data of the infrared sensor might be important in resolving the person-object distinction. Thus, data of the infrared sensor might be a critical variables in further classifying the event as an approaching person.

To identify the set of critical variables describing the event, an embodiment uses a latent semantic analysis technique. Latent semantic analysis (LSA) is a technique, typically used in natural language processing, of analyzing relationships between a set of documents and the terms they contain by producing a set of concepts related to the documents and terms. Here, an embodiment implements LSA to analyze relationships between events and the significant data of the events. To use LSA, an embodiment constructs a matrix containing term counts per event (rows represent terms and columns represent an event) and uses a mathematical technique called singular value decomposition (SVD) to reduce the number of rows while preserving the similarity structure among columns. Then, to compare two events, an embodiment treats columns representing each event as vectors and computes the cosine of the angle between two vectors (or the dot product between the normalizations of the two vectors). Values close to 1 represent very similar events while values close to 0 represent very dissimilar events. If two events have more than a threshold similarity to each other, both events can be treated as one type of event and terms contributing to both events are likely to correspond to critical variables describing the event type.

An embodiment adds the set of critical variables to a sensor equivalence ontology classified by event type. For example, an event type of “person approaching” might include video data corresponding to an object approaching, as well as infrared sensor data of an object radiating heat consistent with human body temperature.

An embodiment uses the ontology to classify a new set of sensor data, in a manner described herein, as including an event of a known event type. For example, consider an ontology that already contains an event type of “person approaching”, including the information that video and infrared sensor data are important in classifying this event type. Then, when receiving a new set of sensor data that also includes video and corresponding infrared sensor data, although from sensors having different characteristics or including additional types of sensor data, an embodiment can use the ontology to characterize this new event as also being of an event type of “person approaching”. Thus, an embodiment classifies a sensor in one device and a sensor in another IoT device to be different variants of a class of sensors that is configurable to sense an event type. In other words, an embodiment uses the ontology to cross-reference equivalent sensor data used to determine a particular event type.

The manner of an Internet of Things sensor equivalence ontology described herein is unavailable in the presently available methods in the technological field of endeavor pertaining to event analysis within sensor data. A method of an embodiment described herein, when implemented to execute on a device or data processing system, comprises substantial advancement of the functionality of that device or data processing system in collecting sensor data, extracting and weighting significant sensor data, analyzing the weighted significant sensor data to determine critical variables corresponding to an event type classification, assembling the critical variable information into an Internet of Things sensor equivalence ontology, and using the resulting ontology to classify sensor data into an event type.

The illustrative embodiments are described with respect to certain types of events, terms, factors, weights, variables, periods, thresholds, adjustments, sensors, sensor data, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

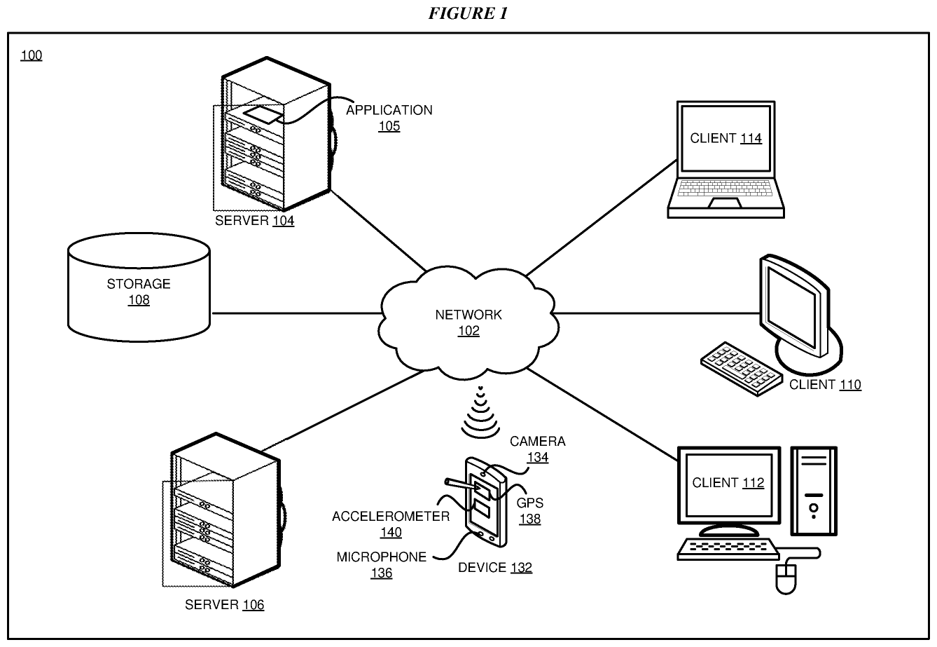

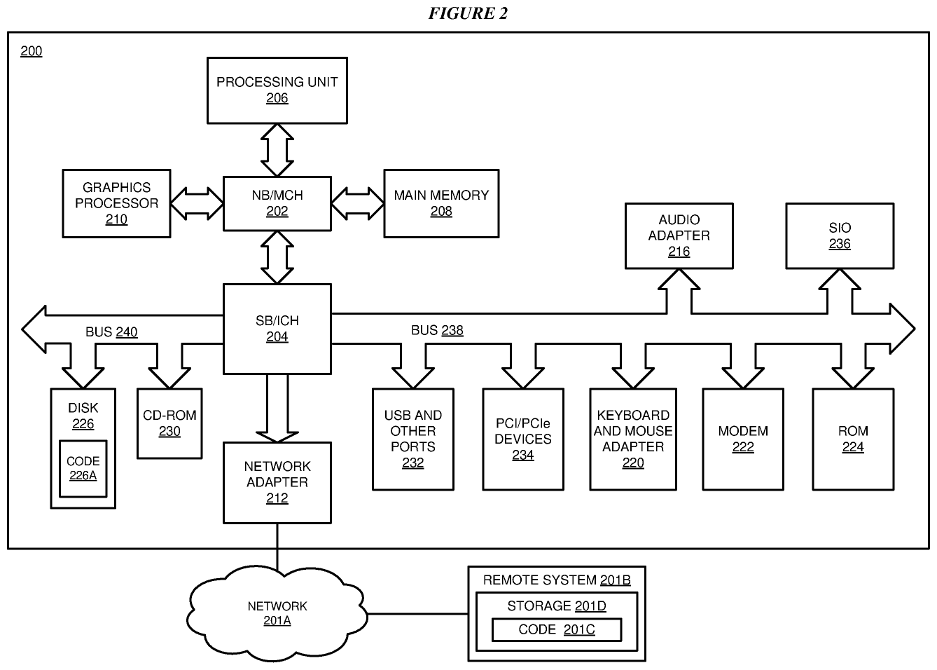

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Device 132 includes camera 134, microphone 136, GPS 138, and accelerometer 140. Camera 134, microphone 136, GPS 138, and accelerometer 140 are examples of sensors that can be used to collect sensor data and detect an event within sensor data.

Application 105 implements an embodiment described herein. Application 105 can execute in any of servers 104 and 106, clients 110, 112, and 114, and device 132 to collect data from any of camera 134, microphone 136, GPS 138, and accelerometer 140, as well as additional or different sensors.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

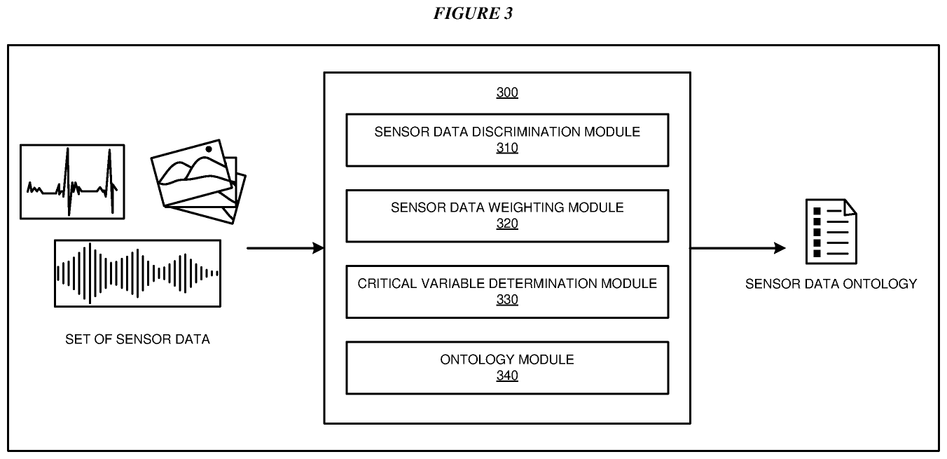

With reference to FIG. 3, this figure depicts a block diagram of an example configuration for an Internet of Things sensor equivalence ontology in accordance with an illustrative embodiment. Application 300 is an example of application 105 in FIG. 1 and executes in any of servers 104 and 106, clients 110, 112, and 114, and device 132 in FIG. 1.

Application 300 collects sets of sensor data, each set including data collected during a period of time, as well as optional data regarding an event detected within the set of sensor data. Each set of sensor data includes sensor data from a sensor in an IoT device, for example device 132. An IoT device is configurable to include one or more sensors. Application 300 is configurable to collect sensor data, or to receive reported sensor data, continuously, at a particular time interval, or when an IoT device-based analysis indicates that a particular event has occurred. Application 300 is also configurable to collect sensor data from a sensor that did not generate the original event data, or from a data source other than a sensor, such as a database or data available on a network such as the Internet.

Sensor data discrimination module 310 extracts a set of significant sensor data from a collected set of sensor data, by removing nonessential data from the collected set of sensor data. To extract significant sensor data, module 310 uses a statistical model appropriate to the particular sensor or type of sensor that generated the data.

If sensor data is separable into signal and noise components, module 310 uses a suitable technique to remove noise from the sensor data, leaving only a set of significant sensor data. If sensor data is of a type for which data that is not significant is data that occurs with more than a threshold frequency, or data detected at more than a threshold number of sensors within a predetermined time range, module 310 uses a statistical model, specific to the type of data or to the particular sensor that collected the data, to remove data that occurs with more than a threshold frequency, or data detected at more than a threshold number of sensors within a predetermined time range, leaving only a set of significant sensor data. Module 310 is also configurable to use another presently-available technique to extract significant data.

Sensor data weighting module 320 divides the set of significant sensor data into a set of terms, and weights each term according to a set of factors. Module 320 can be configured to use weights for each factor that are determined by human experts, either individually or according to a policy. Weights can also be determined using a machine learning process, in which a model learns, using any presently-available technique, weight values that are most effective in processing particular types of sensor data or data output by a particular sensor or a sensor with a particular set of characteristics. Module 320 can also be configured to use weights determined by a combination of factors.

One factor is a sensor data frequency factor, i.e. the number of times a particular portion of sensor data appears within the set of significant sensor data. Another factor is a collection frequency factor, i.e. the number of sensors that produced the same sensor data, sets of sensor data matching each other within a predetermined tolerance, or classified the same event within the sensor data. Another factor is a data length normalization factor, to normalize differences between how much data a particular sensor collects for a particular event.

Critical variable determination module 330 uses the weighted set of terms to build a vector space representation of the set of terms, and analyzes the weighted set of terms to identify a set of critical variables describing the event. To identify the set of critical variables describing the event, module 330 uses a latent semantic analysis technique. In particular, module 330 constructs a matrix containing term counts per event (rows represent terms and columns represent an event) and uses a mathematical technique called singular value decomposition (SVD) to reduce the number of rows while preserving the similarity structure among columns. Then, to compare two events, module 330 treats columns representing each event as vectors and computes the cosine of the angle between two vectors (or the dot product between the normalizations of the two vectors). Values close to 1 represent very similar events while values close to 0 represent very dissimilar events. If two events have more than a threshold similarity to each other, both events can be treated as one type of event and terms contributing to both events are likely to correspond to critical variables describing the event type.

Ontology module 340 maintains an Internet of Things sensor equivalence ontology classified by event type. For each event type, module 340 stores the set of critical variables corresponding to an event. Application 300 uses data from module 340 to classify a new set of sensor data, as including an event of a known event type. In particular, application 300 classifies a sensor in one device and a sensor in another IoT device to be different variants of a class of sensors that is configurable to sense an event type. In other words, application 300 uses the ontology to cross-reference equivalent sensor data used to determine a particular event type.

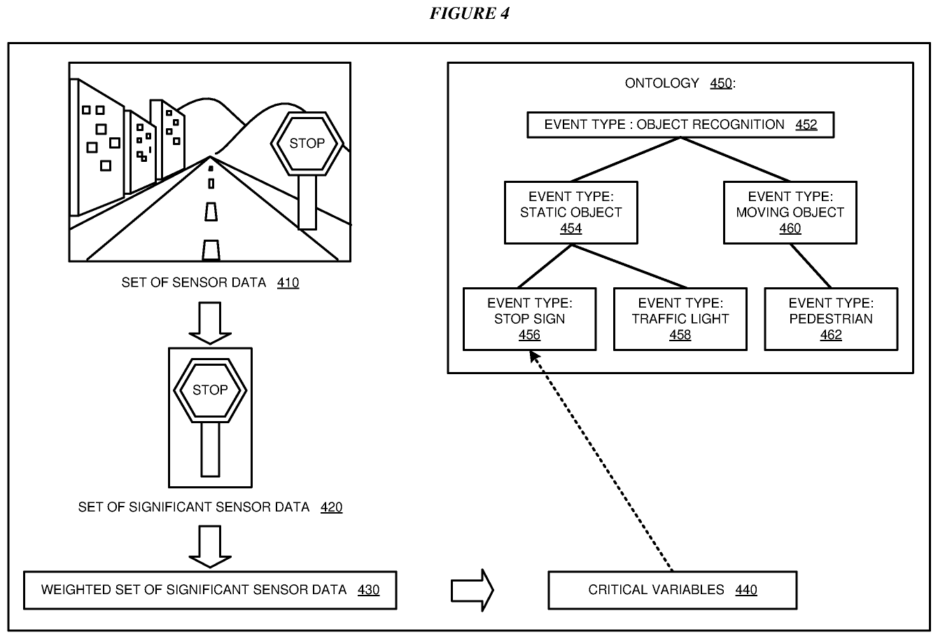

With reference to FIG. 4, this figure depicts an example of analyzing data for an Internet of Things sensor equivalence ontology in accordance with an illustrative embodiment. The example can be executed using application 300 in FIG. 3.

Ontology 450 includes event type 452, the object recognition event type. Event type 452 includes two subtypes: event type 454, the static object event type, and event type 460, the moving object event type. Event type 454 includes two subtypes: event type 456, the stop sign event type, and event type 458, the traffic light event type, as well as additional event types (not shown) that are subtypes of a static object event type. Event type 460 includes one subtype: event type 462, the pedestrian event type, as well as additional event types (not shown) that are subtypes of a moving object event type. Thus, ontology 450 stores event types as well as logical relationships between event types.

Set of sensor data 410 includes image data, for example obtained by an autonomous vehicle. The autonomous vehicle has also identified an event of interest within data 410—the vehicle is approaching a stop sign. Data 410 also includes additional sensor data (not shown). The additional data includes one or more of the GPS location of the vehicle, the air temperature outside the vehicle, sound data for the area adjacent to the vehicle, and distance data, measured by lidar, to the stop sign and other objects within distance measurement range.

Application 300 extracts set of significant sensor data 420 from a collected set of sensor data, by removing nonessential data from the collected set of sensor data. Here, for the image data in data 410, application 300 has removed the background data, leaving only the stop sign.

Application 300 divides set of significant sensor data 420 into a set of terms, and weights each term according to a set of factors, generating weighted set of significant sensor data 430. Application 300 analyzes data 430 to identify critical variables 440 describing the event, and adds critical variables 440 to event type 456, the stop sign event type, within ontology 450.

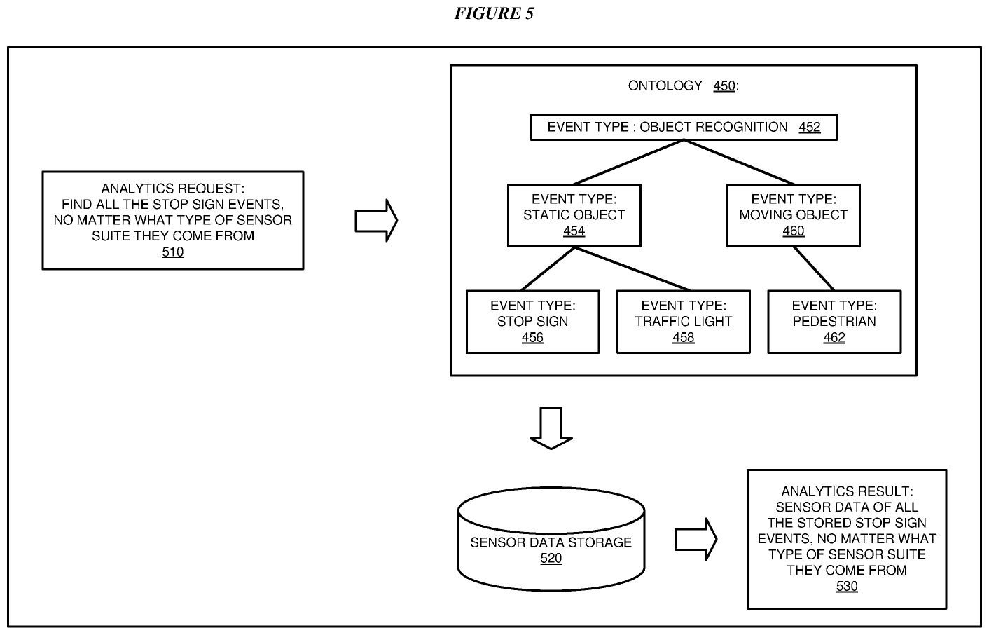

With reference to FIG. 5, this figure depicts an example of using an Internet of Things sensor equivalence ontology to analyze data in accordance with an illustrative embodiment. Ontology 450 and event types 452, 454, 456, 458, 460, and 462 are the same as ontology 450 and event types 452, 454, 456, 458, 460, and 462 in FIG. 4. The example can be executed using application 300 in FIG. 3.

Application 300 receives analytics request 510, to find all the stop sign events stored in sensor data storage 520, no matter what type of sensor suite the event data was collected using. Application 300 consults event type 456, the stop sign event type, within ontology 450, to obtain information on critical variables used to determine a stop sign event and to cross-reference equivalent sensor data used to determine event type 456. Using this data, application 300 obtains sensor data matching event type 456 from storage 520, producing analysis result 530, sensor data of all the stop sign events stored in sensor data storage 520, no matter what type of sensor suite the event data was collected using.

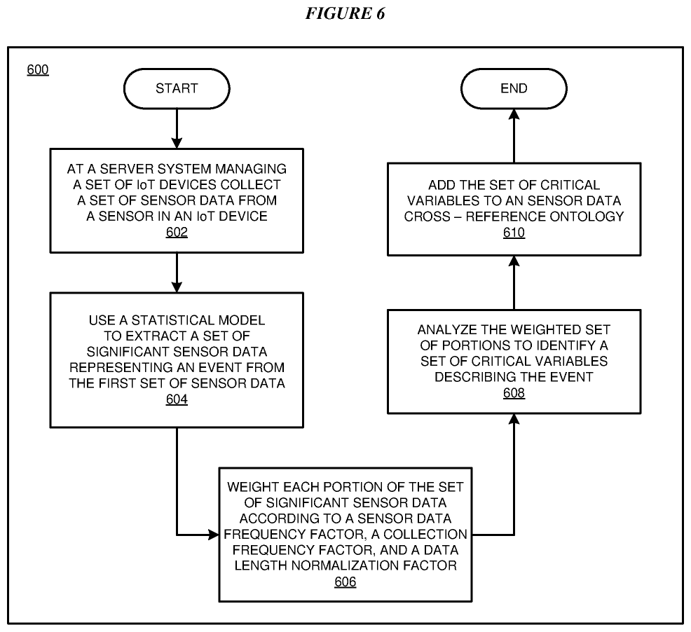

With reference to FIG. 6, this figure depicts a flowchart of an example process for an Internet of Things sensor equivalence ontology in accordance with an illustrative embodiment. Process 600 can be implemented in application 300 in FIG. 3.

In block 602, the application, at a server system managing a set of IoT devices, collects a set of sensor data from a sensor in an IoT device. In block 604, the application uses a statistical model to extract a set of significant sensor data representing an event from the first set of sensor data. In block 606, the application weights each portion of the set of significant sensor data according to a sensor data frequency factor, a collection frequency factor, and a data length normalization factor. In block 608, the application analyzes the weighted set of portions to identify a set of critical variables describing the event. In block 610, the application adds the set of critical variables to a sensor data cross-reference ontology. Then the application ends.

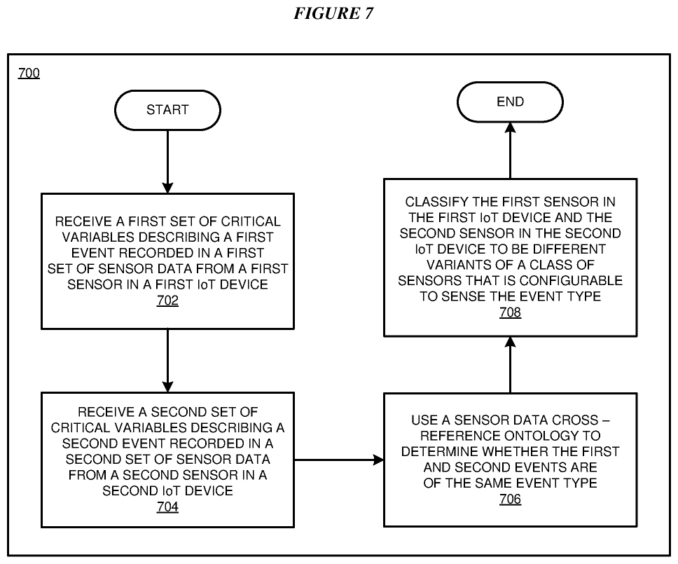

With reference to FIG. 7, this figure depicts a flowchart of an example process for an Internet of Things sensor equivalence ontology in accordance with an illustrative embodiment. Process 700 can be implemented in application 300 in FIG. 3.

In block 702, the application receives a first set of critical variables describing a first event recorded in a first set of sensor data from a first sensor in a first IoT device. In block 704, the application receives a second set of critical variables describing a second event recorded in a second set of sensor data from a second sensor in a second IoT device. In block 706, the application uses a sensor data cross-reference ontology to determine whether the first and second events are of the same event type. In block 708, the application classifies the first sensor in the first IoT device and the second sensor in the second IoT device to be different variants of a class of sensors that is configurable to sense the event type. Then the application ends.

Thus, a computer implemented method, system or apparatus, and computer program product are provided in the illustrative embodiments for an Internet of Things sensor equivalence ontology and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
collecting, at a server system managing a set of IoT devices, a first set of sensor data from a first sensor in a first IoT device and a second set of sensor data from a second sensor in a second IoT device;
extracting, using a statistical model, a first set of significant sensor data from the first set of sensor data, the first set of sensor data including data of a first event, the first set of significant sensor data representing the first event;
weighting, according to a set of factors, each term in a first set of terms, a term in the first set of terms comprising a portion of the first set of significant sensor data;
identifying, by analyzing the weighted first set of terms, a first set of critical variables describing the first event;
adding, to an ontology, the first set of critical variables;
extracting, using the statistical model, a second set of significant sensor data from the second set of sensor data, the second set of sensor data including data of a second event, the second set of significant sensor data representing the second event;
weighting, according to the set of factors, each term in a second set of terms, a term in the second set of terms comprising a portion of the second set of significant sensor data;
identifying, by analyzing the weighted second set of terms, a second set of critical variables describing the first event;
adding, to the ontology, the second set of critical variables;
determining, using the ontology, that the first event is of an event type of the second event; and
classifying the first sensor in the first IoT device and the second sensor in the second IoT device to be different variants of a class of sensors that is configurable to sense the event type.

2. The computer-implemented method of claim 1, wherein extracting, using a statistical model, the first set of significant sensor data from the first set of sensor data comprises:
separating the first set of sensor data into a signal component and a noise component; and
using, as the first set of significant sensor data, the signal component.

3. The computer-implemented method of claim 1, wherein the first set of significant sensor data comprises sensor data occurring with less than a threshold frequency.

4. The computer-implemented method of claim 1, wherein the first set of significant sensor data comprises sensor data collected at fewer than a threshold number of sensors within a predetermined time range.

5. The computer-implemented method of claim 1, wherein a factor in the set of factors comprises a sensor data frequency factor.

6. The computer-implemented method of claim 1, wherein a factor in the set of factors comprises a collection data frequency factor.

7. The computer-implemented method of claim 1, wherein a factor in the set of factors comprises a data length normalization factor.

8. A computer usable program product comprising one or more computer-readable storage devices, and program instructions stored on at least one of the one or more storage devices, the stored program instructions comprising:
program instructions to collect, at a server system managing a set of IoT devices, a first set of sensor data from a first sensor in a first IoT device and a second set of sensor data from a second sensor in a second IoT device;
program instructions to extract, using a statistical model, a first set of significant sensor data from the first set of sensor data, the first set of sensor data including data of a first event, the first set of significant sensor data representing the first event;
program instructions to weight, according to a set of factors, each term in a first set of terms, a term in the first set of terms comprising a portion of the first set of significant sensor data;
program instructions to identify, by analyzing the weighted first set of terms, a first set of critical variables describing the first event;
program instructions to add, to an ontology, the first set of critical variables;
extracting, using the statistical model, a second set of significant sensor data from the second set of sensor data, the second set of sensor data including data of a second event, the second set of significant sensor data representing the second event;
program instructions to weight, according to the set of factors, each term in a second set of terms, a term in the second set of terms comprising a portion of the second set of significant sensor data;
program instructions to identify, by analyzing the weighted second set of terms, a second set of critical variables describing the first event;
program instructions to add, to the ontology, the second set of critical variables;
program instructions to determine, using the ontology, that the first event is of an event type of the second event; and
program instructions to classify the first sensor in the first IoT device and the second sensor in the second IoT device to be different variants of a class of sensors that is configurable to sense the event type.

9. The computer usable program product of claim 8, wherein program instructions to extract, using a statistical model, the first set of significant sensor data from the first set of sensor data comprises:
program instructions to separate the first set of sensor data into a signal component and a noise component; and
program instructions to use, as the first set of significant sensor data, the signal component.

10. The computer usable program product of claim 8, wherein the first set of significant sensor data comprises sensor data occurring with less than a threshold frequency.

11. The computer usable program product of claim 8, wherein the first set of significant sensor data comprises sensor data collected at fewer than a threshold number of sensors within a predetermined time range.

12. The computer usable program product of claim 8, wherein a factor in the set of factors comprises a sensor data frequency factor.

13. The computer usable program product of claim 8, wherein a factor in the set of factors comprises a collection data frequency factor.

14. The computer usable program product of claim 8, wherein a factor in the set of factors comprises a data length normalization factor.

15. The computer usable program product of claim 8, wherein the stored program instructions are stored in the at least one of the one or more storage devices of a local data processing system, and wherein the stored program instructions are transferred over a network from a remote data processing system.

16. The computer usable program product of claim 8, wherein the stored program instructions are stored in the at least one of the one or more storage devices of a server data processing system, and wherein the stored program instructions are downloaded over a network to a remote data processing system for use in a computer readable storage device associated with the remote data processing system.

17. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to collect, at a server system managing a set of IoT devices, a first set of sensor data from a first sensor in a first IoT device and a second set of sensor data from a second sensor in a second IoT device;
program instructions to extract, using a statistical model, a first set of significant sensor data from the first set of sensor data, the first set of sensor data including data of a first event, the first set of significant sensor data representing the first event;
program instructions to weight, according to a set of factors, each term in a first set of terms, a term in the first set of terms comprising a portion of the first set of significant sensor data;
program instructions to identify, by analyzing the weighted first set of terms, a first set of critical variables describing the first event;
program instructions to add, to an ontology, the first set of critical variables;
extracting, using the statistical model, a second set of significant sensor data from the second set of sensor data, the second set of sensor data including data of a second event, the second set of significant sensor data representing the second event;
program instructions to weight, according to the set of factors, each term in a second set of terms, a term in the second set of terms comprising a portion of the second set of significant sensor data;
program instructions to identify, by analyzing the weighted second set of terms, a second set of critical variables describing the first event;
program instructions to add, to the ontology, the second set of critical variables;
program instructions to determine, using the ontology, that the first event is of an event type of the second event; and
program instructions to classify the first sensor in the first IoT device and the second sensor in the second IoT device to be different variants of a class of sensors that is configurable to sense the event type.

18. The computer system of claim 17, wherein program instructions to extract, using a statistical model, the first set of significant sensor data from the first set of sensor data comprises:
program instructions to separate the first set of sensor data into a signal component and a noise component; and
program instructions to use, as the first set of significant sensor data, the signal component.

19. The computer system of claim 17, wherein the first set of significant sensor data comprises sensor data occurring with less than a threshold frequency.

20. The computer system of claim 17, wherein the first set of significant sensor data comprises sensor data collected at fewer than a threshold number of sensors within a predetermined time range.
